(19) United States
(12) Patent Application Publication
(10) Pub. No.: US 2025/0324054 A1
(43) Pub. Date: Oct. 16, 2025

(54) QUANTIZATION COMPENSATION THROUGH LEARNED INVERSE TRANSFORM KERNEL FOR VIDEO CODING

(71) Applicant: Tencent America LLC, Palo Alto, CA (US)

(72) Inventors: Yifan WANG, Palo Alto, CA (US); Roman CHERNYAK, Santa Clara, CA (US); Yonguk YOON, Palo Alto, CA (US); Motong XU, Palo Alto, PA (US); Ziyue XIANG, Palo Alto, CA (US); Biao WANG, San Jose, CA (US); Tianqi LIU, Palo Alto, CA (US); Lien-Fei CHEN, Palo Alto, CA (US); Shan LIU, San Jose, CA (US)

(73) Assignee: Tencent America LLC, Palo Alto, CA (US)

(21) Appl. No.: 19/175,854

(22) Filed: Apr. 10, 2025

Related U.S. Application Data
(60) Provisional application No. 63/633,760, filed on Apr. 13, 2024.
(60) Provisional application No. 63/645,096, filed on May 9, 2024.

(51) Int. Cl. H04N 19/122; H04N 19/167; H04N 19/176; H04N 19/196; H04N 19/70

(52) U.S. Cl. CPC H04N 19/122; H04N 19/167; H04N 19/176; H04N 19/196; H04N 19/70

(57) ABSTRACT

A bitstream includes coded information of a block, the coded information includes quantized spectrum domain coefficients corresponding to a residual block of the block, the residual block is transformed from a spatial domain to spectrum domain coefficients in a spectrum domain according to a transform kernel, the spectrum domain coefficients are quantized into the quantized spectrum domain coefficients according to a quantization parameter value. A modified inverse transform kernel is determined to be used for the block, the modified inverse transform kernel is different from an inverse of the transform kernel to compensate an influence of quantization on the spectrum domain coefficients. A dequantization is performed on the quantized spectrum domain coefficients to obtain dequantized spectrum domain coefficients. An inverse transform is performed on the dequantized spectrum domain coefficients according to the modified inverse transform kernel to obtain a reconstructed residual block for the reconstruction of the block.

### INCORPORATION BY REFERENCE

The present application claims the benefit of priority to U.S. Provisional Application No. 63/633,760, filed on Apr. 13, 2024, and U.S. Provisional Application No. 63/645,096, filed on May 9, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

An aspect of the disclosure provides a method of video decoding. For example, a coded video bitstream is received. The coded video bitstream includes coded information of a block in a picture, the coded information includes quantized spectrum domain coefficients corresponding to a residual block of the block, the residual block is transformed from a spatial domain to spectrum domain coefficients in a spectrum domain according to a transform kernel, the spectrum domain coefficients are quantized into the quantized spectrum domain coefficients according to a quantization parameter value. Based on the coded information, a modified inverse transform kernel is determined to be used for the block in the picture, the modified inverse transform kernel is different from an inverse of the transform kernel to compensate an influence of quantization on the spectrum domain coefficients. A dequantization is performed on the quantized spectrum domain coefficients to obtain dequantized spectrum domain coefficients. An inverse transform is performed on the dequantized spectrum domain coefficients according to the modified inverse transform kernel to obtain a reconstructed residual block. The block is reconstructed based on the reconstructed residual block.

Another aspect of the disclosure provides a method of video encoding. For example, a residual block of a block in a spatial domain is transform to spectrum domain coefficients in a spectrum domain according to a transform kernel. A quantization is performed on the spectrum domain coefficients according to a quantization parameter value to obtain quantized spectrum domain coefficients. The quantized spectrum domain coefficients are encoded into coded information of the block in a bitstream. To use a modified inverse transform kernel for a reconstruction of the block is determined. The modified inverse transform kernel is different from an inverse of the transform kernel to compensate an influence of the quantization on the spectrum domain coefficients. The reconstruction is performed according to the modified inverse transform kernel.

Another aspect of the disclosure provides a method of processing visual media data is provided. In the method, a conversion between a visual media file and a bitstream of visual media data is performed according to a format rule. In an example, the bitstream carries coded information of a block in a picture, the coded information includes quantized spectrum domain coefficients corresponding to a residual block of the block, the residual block is transformed from a spatial domain to spectrum domain coefficients in a spectrum domain according to a transform kernel, the spectrum domain coefficients are quantized into the quantized spectrum domain coefficients according to a quantization parameter value. The format rule specifies that: based on the coded information, to use a modified inverse transform kernel for the block in the picture is determined, the modified inverse transform kernel is different from an inverse of the transform kernel to compensate an influence of quantization on the spectrum domain coefficients. The format rule also specifies that dequantization is performed on the quantized spectrum domain coefficients to obtain dequantized spectrum domain coefficients; an inverse transform is performed on the dequantized spectrum domain coefficients according to the modified inverse transform kernel to obtain a reconstructed residual block; and the block is reconstructed based on the reconstructed residual block.

An aspect of the disclosure provides a method of video decoding. For example, a coded video bitstream is received. The coded video bitstream includes coded information of a block in a picture, the coded information includes coded information of spectrum domain coefficients corresponding to a residual block of the block, the residual block in a spatial domain is transformed into the spectrum domain coefficients in a spectrum domain according to a transform kernel. An inverse transform is performed on the spectrum domain coefficients according to an inverse transform kernel and an orthogonality compensation term to obtain a reconstructed residual block, the inverse transform kernel is an inverse of the transform kernel with integer rounding, the orthogonality compensation term compensates a non-orthogonality of the inverse transform kernel and the transform kernel. The block is reconstructed based on the reconstructed residual block.

Another aspect of the disclosure provides a method of video encoding. For example, to apply an orthogonality compensation term on a block in a picture is determined. A forward transform is performed on a residual block of the block in a spatial domain according to a transform kernel and the orthogonality compensation term to obtain compensated spectrum domain coefficients in a spectrum domain. The orthogonality compensation term compensates a non-orthogonality of the transform kernel and an inverse transform kernel, the inverse transform kernel is an inverse of the transform kernel with integer rounding. The block is encoded into coded information of the block in a bitstream based on the compensated spectrum domain coefficients.

Another aspect of the disclosure provides a method of processing visual media data is provided. In the method, a conversion between a visual media file and a bitstream of visual media data is performed according to a format rule. In an example, the bitstream carries coded information of a block in a picture, the coded information includes coded information of spectrum domain coefficients corresponding to a residual block of the block, the residual block in a spatial domain is transformed into the spectrum domain coefficients in a spectrum domain according to a transform kernel. The format rule specifies that an inverse transform of the spectrum domain coefficients is performed according to an inverse transform kernel and an orthogonality compensation term to obtain a reconstructed residual block, the inverse transform kernel is an inverse of the transform kernel with integer rounding, the orthogonality compensation term compensates a non-orthogonality of the inverse transform kernel and the transform kernel. The block is reconstructed based on the reconstructed residual block.

Aspects of the disclosure also provide an apparatus for video encoding. The apparatus for video encoding includes processing circuitry configured to implement any of the described methods for video encoding.

Aspects of the disclosure also provide an apparatus for video decoding. The apparatus for video decoding includes processing circuitry configured to implement any of the described methods for video decoding.

Aspects of the disclosure also provide a non-transitory computer-readable medium storing instructions which, when executed by a computer, cause the computer to perform any of the described methods for video decoding/encoding.

Aspects of the disclosure include bitstreams, methods and apparatuses for learning an inverse transform kernel for quantization compensation.

An aspect of the disclosure provides a method of leaning for quantization compensation. In an example, at least a pair of a training residual block and first dequantized spectrum domain coefficients of the training residual block is obtained, the training residual block is transformed into training spectrum domain coefficients according to a transform kernel, and the training spectrum domain coefficients are quantized and dequantized based on a first quantization parameter value into the first dequantized spectrum domain coefficients. A modified inverse transform kernel is determined based on at least the pair of the training residual block and the first dequantized spectrum domain coefficients of the training residual block.

Aspects of the disclosure also provide an apparatus of leaning for quantization compensation. The apparatus for learning for quantization compensation includes processing circuitry configured to implement any of the described methods of learning for quantization compensation.

Aspects of the disclosure also provide a non-transitory computer-readable medium storing instructions which, when executed by a computer, cause the computer to perform any of the described methods of leaning for quantization compensation.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram of distribution comparison of a spectrum domain coefficient with and without quantization in an example.

FIG. 5 shows results of a dot product of a transform kernel and its inverse transform kernel in an example.

FIG. 6 shows a flow chart outlining a learning process according to an aspect of the disclosure.

FIG. 7 shows a flow chart outlining a process according to an aspect of the disclosure.

FIG. 8 shows a flow chart outlining a process according to an aspect of the disclosure.

FIG. 9 shows a flow chart outlining a process according to an aspect of the disclosure.

FIG. 10 shows a flow chart outlining a process according to an aspect of the disclosure.

FIG. 11 is a schematic illustration of a computer system in accordance with an aspect.

### DETAILED DESCRIPTION

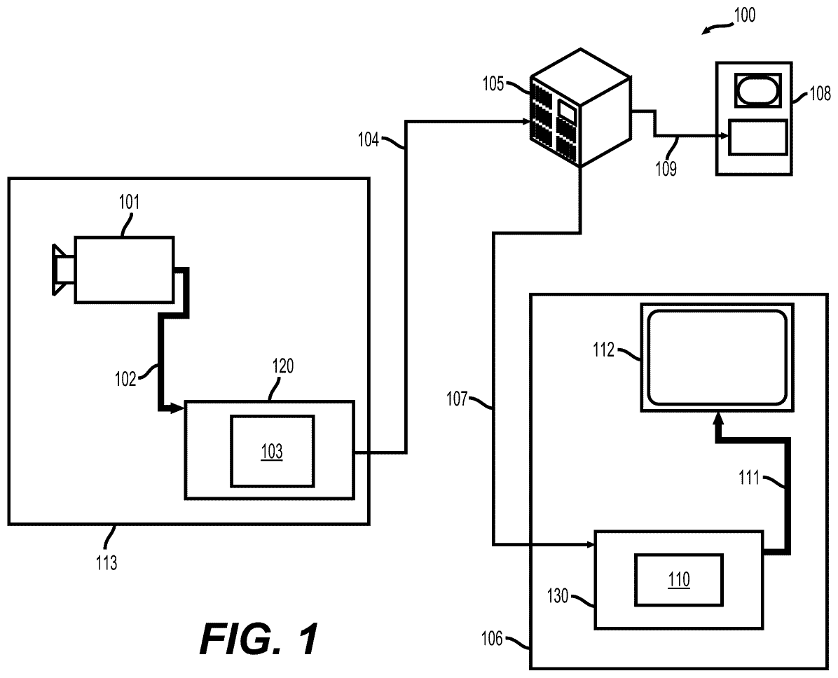

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

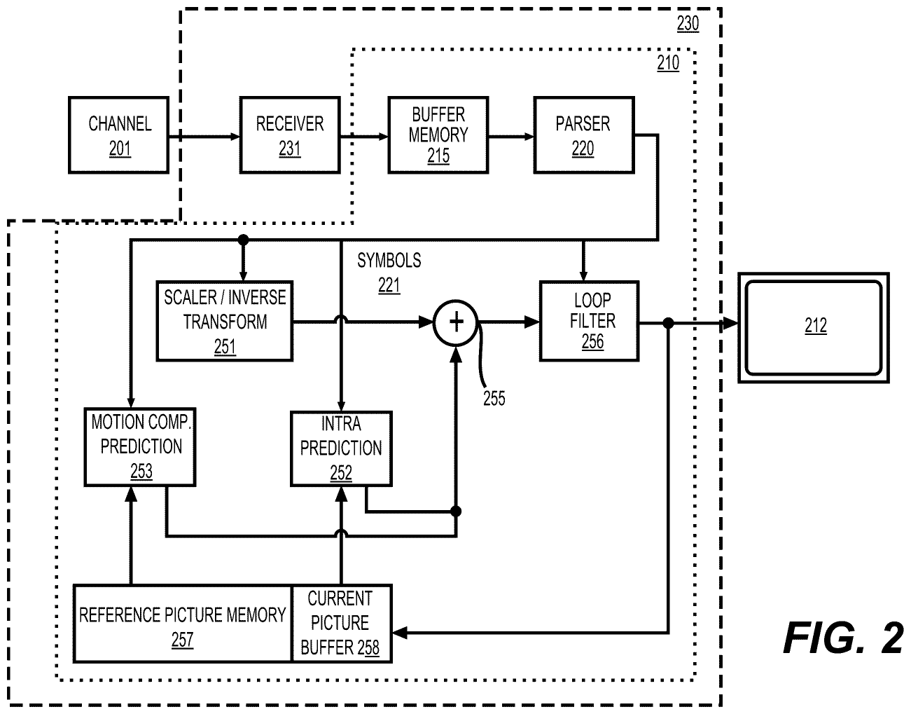

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

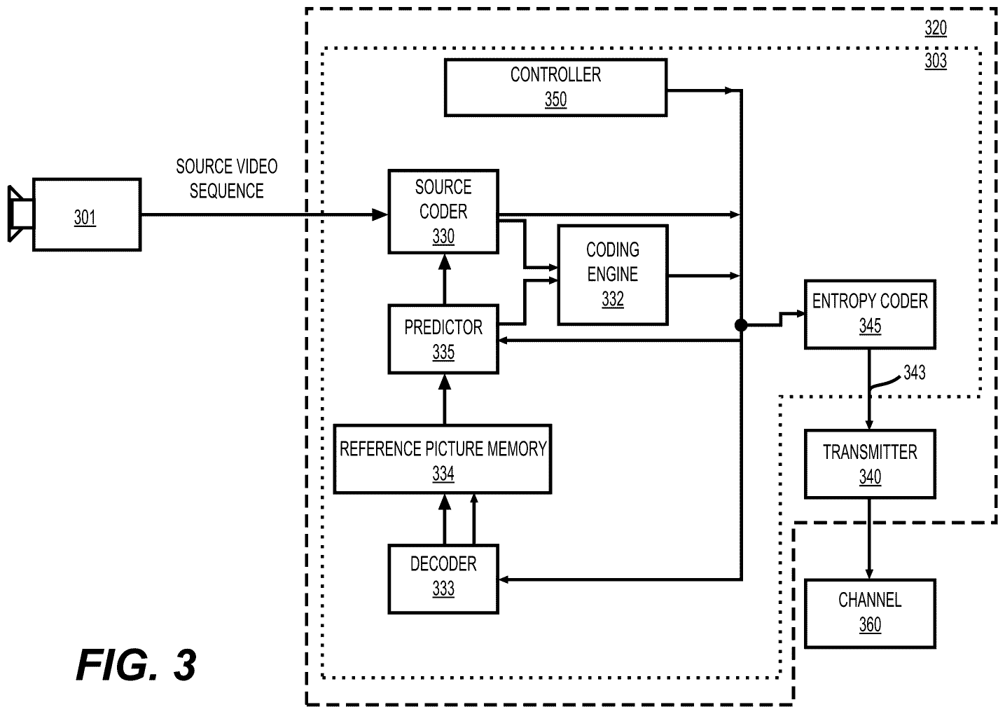

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the disclosure provide techniques of transform kernel derivation. In some aspects, inverse transform kernel for video coding can be trained to model quantization errors. In some aspects, some techniques can improve the orthogonality of transform kernels.

A video coding framework can include various modules, such as intra prediction, inter prediction, transform, quantization, in-loop filter and the like. In video codec, techniques, such as transform, quantization, and the like are used to reduce redundancy and improve coding efficiency in video signals. For example, transform techniques can reduce redundancy in the video signal by decorrelation, and quantization techniques can decrease the data of the transform coefficient representation by reducing precision, for example by removing imperceptible details, and thus reducing irrelevance in the data.

In some examples, transformation decorrelates a signal by transforming the signal from the spatial domain to a transform domain (e.g., a frequency domain), using a suitable transform basis. For example, a transform is applied to the prediction residual (regardless of whether it comes from inter- or intra-picture prediction), that is, the difference between the prediction and the original input video signal. In the transform domain, the essential information typically concentrates into a small number of coefficients. At the decoder, the inverse transform can be applied to reconstruct the residual samples.

Generally, quantization is used to reduce the precision of an input value or a set of input values in order to decrease the amount of data needed to represent the values. In some examples, the quantization is typically applied to individual transformed residual samples (e.g., transform coefficients), resulting in integer coefficient levels. The quantization process is applied at the encoder. At the decoder, the corresponding process is known as inverse quantization (also referred to as dequantization), which restores the original value range without regaining the precision.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode). In some examples, a lookup table is used, and the lookup table maps LFNST sets to intra prediction modes.

In some aspects, different types of DCT are available as candidates, and a suitable DCT can be selected to improve coding efficiency. In some examples, non-separable primary transform (NSPT) and low-frequency non-separable transform (LFNST) provide learned kernels to maximize the energy compaction ability. At the decoder side, the linear (inverse) transform kernel is applied on the de-quantized coefficient to reconstruct the spatial blocks.

Some aspects of the present disclosure provide techniques for training the inverse transform kernel to improve the compression efficiency further. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium. The techniques can be implemented in various video coding standards, such as H264, H265, H266 (VVC), AV 1, AVS, and the like.

For example, at the encoder side, a residual block of a block is transformed from a spatial domain to spectrum domain coefficients in a spectrum domain according to a transform kernel, the spectrum domain coefficients are quantized into the quantized spectrum domain coefficients according to a quantization parameter value, the quantized spectrum domain coefficients can be encoded into coded information of the block. At the decoder side, based on the coded information, to use a modified inverse transform kernel for the block is determined. The modified inverse transform kernel is different from an inverse of the transform kernel to compensate an influence of quantization on the spectrum domain coefficients. The decoder can perform a dequantization on the quantized spectrum domain coefficients to obtain dequantized spectrum domain coefficients. The decoder can perform an inverse transform on the dequantized spectrum domain coefficients according to the modified inverse transform kernel to obtain a reconstructed residual block; and reconstruct the block based on the reconstructed residual block.

In some aspects, transform can be generalized into a form of linear transform, such as represented in Eq. (1):

$$tX = X \cdot {K}^{T} \qquad Eq . ( 1 )$$

where tX denotes the spectrum domain coefficients, X denotes the spatial domain residual block, K^{T} denotes the (forward) transform kernel and K denotes the inverse transform kernel. In some examples, tX can be quantized at the encoder side and de-quantized at the decoder side to generate the dequantized spectrum domain coefficients denoted by tX_{q}, such as shown by Eq. (2). The inverse transform is performed on the dequantized spectrum domain coefficients denoted by tX_{q} to get the reconstructed spatial domain residual (also referred to as reconstructed residual block) denoted by iX, such as shown in Eq. (3)

$${tX}_{q} = DeQuant ( Quant ( tX ) ) \qquad Eq . ( 2 )$$

$$iX = {tX}_{q} \cdot K \qquad Eq . ( 3 )$$

It is noted that in the present disclosure, for ease of description, while a transform kernel is used in the description, the transform kernel can be a primary transform kernel, a secondary transform kernel, or a combination of a primary transform kernel and a secondary transform kernel. For example, Eq. 1 can be modified to

$$tX = X \cdot {K}_{1}^{T} \cdot {K}_{2}^{T}$$

when the transform kernel K^{T} includes a primary transform kernel and a secondary transform kernel

$${K}_{1}^{T}$$

and a secondary transform kernel

$${K}_{2}^{T} .$$

According to an aspect of the disclosure, when the inverse transform kernel K is the inverse of the forward transform kernel K^{T}, the inverse transform kernel K may not be optimal for the quantized and dequantized data because of the quantization errors introduced by the quantization of the spectrum domain coefficients.

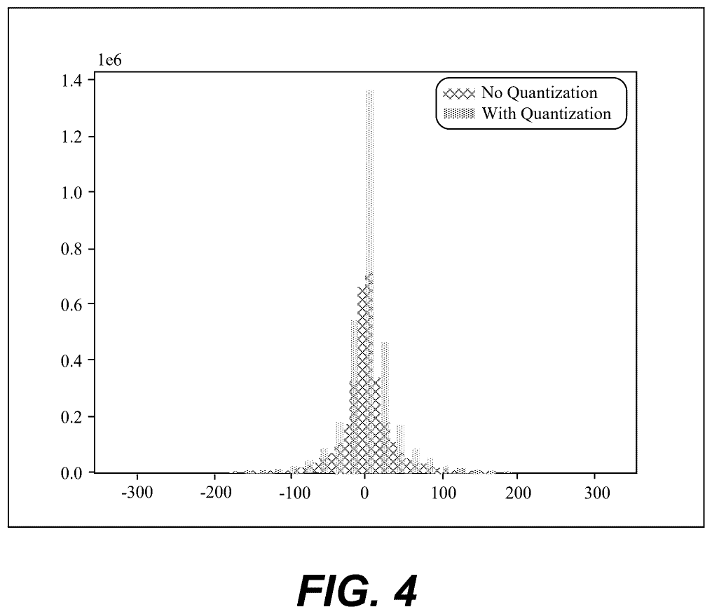

FIG. 4 shows a diagram of distribution comparison of a spectrum domain coefficient with and without quantization in an example. In the FIG. 4 example, the spectrum domain coefficient corresponds to the second component of 4×4 DCT, which is the first frequency component (e.g., first non-DC component) after the forward transform. As shown in FIG. 4, the coefficient's distribution changes after quantization, especially when the quantization step size is large. According to an aspect of the disclosure, using the original inverse transform kernel (inverse of the original forward transform kernel) can reconstruct the input, further the inverse transform kernel can be modified by modeling the influence of quantization on the spectrum domain coefficient's distribution. The modified inverse transform kernel can compensate for the quantization, reduce errors due to quantization, and improve image quality.

In some aspects, a learning (also referred to as training) can be performed based on pairs of information before quantization, and information after quantization to model the influence of the quantization. The information can be in any suitable domain, such as in the spatial domain, in the spectrum domain, and the like.

In some aspects, the modified inverse transform kernel is derived by least square regression, such as represented by Eq. (4):

$${K}_{mod}^{T} = {( {X}^{T} \cdot X )}^{- 1} \cdot {X}^{T} \cdot {tX}_{q} \qquad Eq . ( 4 )$$

where

$${K}_{mod}^{T}$$

denotes the modified transform kernel.

For example, a learning process is performed based on residual blocks to obtain the modified transform kernel. For example, a residual block X is forward transformed by the original transform kernel K^{T} (e.g., according to Eq. (1)) to generate the spectrum domain coefficients tX. The spectrum domain coefficients tX can be quantized and dequantized, for example based on a quantization parameter value, to generate the dequantized spectrum domain coefficients tX_{q} corresponding to the residual block X. The residual block X and the corresponding dequantized spectrum domain coefficients tX_{q} can form a pair. In some examples, one or more pairs of residual blocks and the corresponding dequantized spectrum domain coefficients are used to derive the modified transform kernel

$${K}_{mod}^{T}$$

by least square regression, such as represented by Eq. (4). In an example, the modified inverse transform kernel K_{mod} can be calculated based on the modified transform kernel.

In some examples, the learning process can be performed for each of the quantization parameter values to determine modified inverse transform kernels associated with the quantization parameter values.

In some examples, the derivation of the modified inverse transform kernel is performed for a specific quantization parameter Qp (indicting a quantization step size) that is used in the quantization and the dequantization of the learning process. The derived modified inverse transform kernel can be used to reconstruct the residual for the specific quantization parameter Qp. In some examples, for each quantization parameter, a modified inverse transform kernel is learned.

In some examples, the modified inverse transform kernel obtained for the specific quantization parameter Qp can be applied to other quantization parameters within a range (e.g., ΔQp range). For example, when a difference of another quantization parameter (value) and the specific quantization parameter (value) is within the ΔQp range, then the modified inverse transform kernel obtained for the specific quantization parameter Qp can be used for the other quantization parameter.

It is noted that, in some aspects, the modified inverse-transform kernel can be derived from other methods based on pairs of residual blocks (e.g., raw residual blocks) and the corresponding dequantized spectrum domain coefficients. In some examples, the modified inverse-transform kernel can be learned from for example, a neural network based regression method. In some examples, a probability distribution-based method can be used to compensate for the original transform kernel.

In some aspects, the modified inverse transform kernel can be split into a dot product of a quantization compensation matrix and a standard inverse transform matrix (e.g., corresponding to the original inverse transform kernel).

In an example, the quantization compensation matrix is learned before the inverse transform. For example, the quantization compensation matrix is learn based on a pair of dequantized spectrum domain coefficients tX_{q} and the spectrum domain coefficients tX. For example, a residual block X is forward transformed by the original transform kernel K^{T} (e.g., according to Eq. (1)) to generate the spectrum domain coefficients tX. The spectrum domain coefficients tX can be quantized and dequantized to generate the corresponding dequantized spectrum domain coefficients tX_{q}. The spectrum domain coefficients tX and the corresponding dequantized spectrum domain coefficients tX_{q} can form a pair. In some examples, one or more pairs of the spectrum domain coefficients and the corresponding dequantized spectrum domain coefficients are used to derive the quantization compensation matrix by least square regression. In an example, at the decoder side, the quantization compensation matrix is applied to the dequantized spectrum domain coefficients to generate compensated dequantized spectrum domain coefficients, and then the original inverse transform kernel K is used to perform inverse transform based on the compensated dequantized spectrum domain coefficients.

In another example, the quantization compensation matrix is learned after the inverse transform. For example, the quantization compensation matrix is learn based on a pair of a residual block X and a corresponding reconstructed residual block iX. For example, a residual block X is forward transformed by the original transform kernel K^{T} (e.g., according to Eq. (1)) to generate the spectrum domain coefficients tX. The spectrum domain coefficients tX can be quantized and dequantized to generate the corresponding dequantized spectrum domain coefficients tX_{q}. The original inverse transform kernel K is used to perform inverse transform based on the dequantized spectrum domain coefficients tX_{q} to generate reconstructed residual block iX corresponding to the residual block X. The residual block X and the corresponding reconstructed residual block iX can form a pair. In some examples, one or more pairs of residual blocks and the corresponding reconstructed residual blocks are used to derive the quantization compensation matrix by least square regression. In an example, at the decoder side, the original inverse transform kernel K is used to perform inverse transform based on the dequantized spectrum domain coefficients to generate the reconstructed residual block, and the quantization compensation matrix can be applied to reconstructed residual block to generate the compensated reconstructed residual block.

In some aspects, the inverse transform kernel's Qp-dependent training (also referred to as learning) can be removed by adding a function (also referred to as compensation strength control function) to control the compensation strength. In an example, a modified inverse transform kernel is learned for a specific quantization parameter. For another quantization parameter, a compensation strength control function (e.g., a function of the quantization parameter) can be applied to the modified inverse transform kernel to obtain a compensated inverse transform kernel for the other quantization parameter.

In an example, the compensation strength control function is derived from a fitting of a relationship between quantization parameter and coefficients’ distribution change. The relationship can be linear or non-linear relationship.

In another example, once a modified inverse transform kernel has been trained for a specific quantization parameter, the modified inverse transform kernel can be used for a larger quantization parameter by increasing the compensation strength controlled by the quantization parameter difference. For example, a compensation strength is calculated based on a difference of the specific quantization parameter and the larger quantization parameter. Then, the modified inverse transform kernel is compensated based on the compensation strength to determine a compensated inverse transform kernel for the larger quantization parameter.

In another example, once a modified inverse transform kernel has been trained for a specific quantization parameter, the modified inverse transform kernel can be used for a smaller quantization parameter by decreasing the compensation strength controlled by the quantization parameter difference. For example, a compensation strength is calculated based on a difference of the specific quantization parameter and the smaller quantization parameter. Then, the modified inverse transform kernel is compensated based on the compensation strength to determine a compensated inverse transform kernel for the smaller quantization parameter.

In some aspects, the modified inverse transform can be split into two training stages, such as a horizontal training stage and a vertical training stage to reduce the complexity. In some examples, the inverse transform includes a horizontal inverse transform followed by a vertical inverse transform. In an example, a modified horizontal inverse transform is trained based on (after) the horizontal inverse transform, and a modified vertical inverse transform is trained based on (after) the vertical inverse transform. In some examples, the inverse transform includes a vertical inverse transform followed by a horizontal inverse transform. In an example, a modified vertical inverse transform is trained based on (after) the vertical inverse transform, and a modified horizontal inverse transform is trained based on (after) the horizontal inverse transform.

In some aspects, whether to apply the modified inverse transform can be determined according to block shape, block size, and other coding information. For example, when a size of a block meets a requirement, the inverse transform kernel is modified; when the size of the block fails to meet the requirement, the original inverse transform kernel is used.

In some aspects, the inverse transform kernel can be trained online. In an example, for a long video sequence, the modified inverse transform kernel can be learned from a beginning part of the long video sequence. For example, the original inverse transform kernel is used in the beginning part of the long video sequence, and data is collected to learn a modified inverse transform kernel. In an example, a signal in bitstream can be used to indicate to apply the modified inverse transform kernel on later frames of the long video sequence.

Some aspects of the present disclosure also improve the orthogonality of transform kernels.

In some video codecs (e.g., VVC, ECM, and the like), various transform kernel techniques are used to improve the energy compaction. In some examples, to reduce the coding complexity, integer values are used in the transform kernels. For examples, the transform kernels can be scaled up and rounded to integer values. Certain transform kernels, such as DCT kernels, transform kernels of integer values can retain the orthogonality well. However, for some other transform kernels, such as a learning based transform kernel, and the like, their orthogonality is not guaranteed due to the diversity of the training data and the integer rounding. The dot product of such a transform kernel and its inverse transform is no longer an identity matrix, indicating part of the energy can be lost or unnecessarily increased after the transform/inverse transform within the encoder/decoder pipeline, respectively.

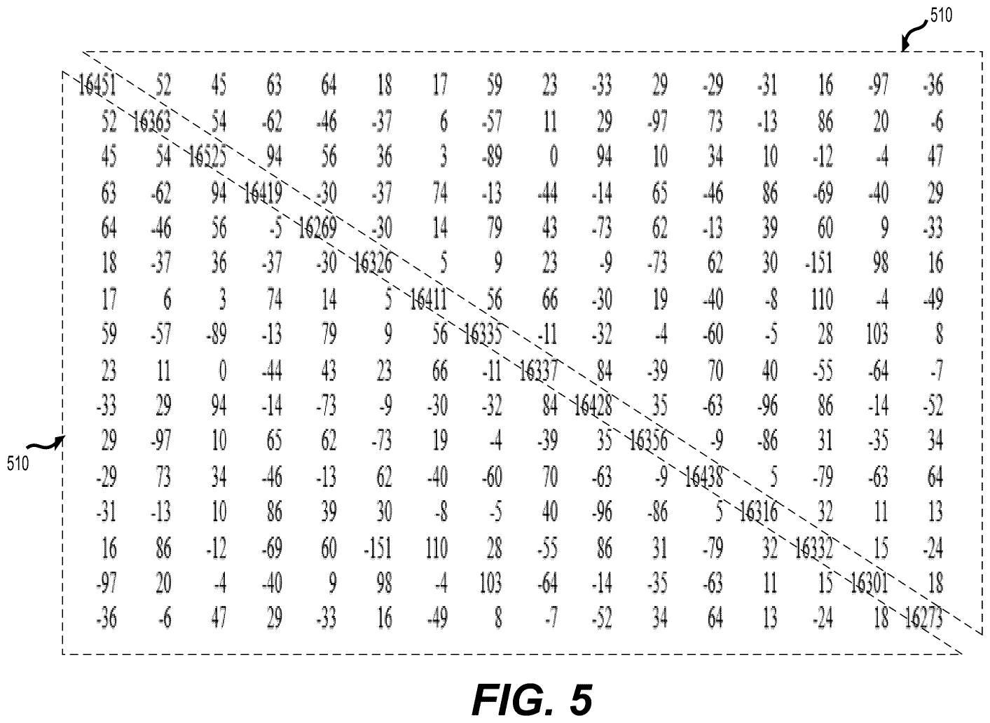

FIG. 5 shows results of a dot product of a transform kernel and its inverse transform kernel in an example. In the FIG. 5 example, all the non-diagonal entries have non zero values.

Some aspects of the present disclosure provide a transform kernel compensation term to reduce the side effect of not having perfectly orthogonal kernels. The transform kernel compensation term can be applied either separately before/after the original transform or can be embedded to the existing transform kernels. For example, encoder/decoder can apply an orthogonality compensation term in the spatial domain and/or spectrum domain at encoder side or decoder side, distribute the orthogonality compensation term into both the encoder side and the decoder side.

In the following description, X denotes a residual block and iX denotes the reconstructed residual block, tX denotes the transform coefficients (also referred to as spectrum domain coefficients), tX_{q} denotes the dequantized transform coefficients (also referred to as dequantized spectrum domain coefficients); K and K^{T} represents original inverse transform kernel and the original transform kernel (also referred to as original forward transform kernel) respectively. In an example, the forward transform is represented by X. K^{T} and the inverse transform is represented by tX_{q}·K.

In some aspects, a compensated inverse transform kernel K′ is derived based on the original forward transform kernel K^{T} and the original inverse transform kernel K. The compensated inverse transform kernel K′ has the compensation embedded and can be used to replace the original inverse transform kernel K during the decoding stage. In an example, the the compensated inverse transform kernel K′ can be derived according to Eq. (5):

$${K}^{′} = int ( K - K \cdot ( \frac{{K}^{T} \cdot K}{{s}^{2}} - I ) ) \qquad Eq . ( 5 )$$

where I represents the identity matrix, s represents the scaling parameter for converting the unit transform kernel to integer.

In an example, the updated inverse transform can be represented by tX_{q}·K′ while the forward transform remains the same represented by X·K^{T}.

In an aspect, a flag is signaled to indicate the compensated inverse transform kernel K′ is applied or not. For example, when this flag is true, the compensated inverse transform kernel K′ is applied for the coded block; otherwise the flag is false, the original transform kernel K is applied for the coded block. This flag can be signaled at any suitable level, such as SPS, PPS, slice header, picture header, CUT level, block level, and the like.

In some aspects, during the decoding stage, a compensated inverse transform kernel K′ can be computed through pseudo inverse, such as shown by Eq. (6) and Eq. (7):

$$SVD ( K ) = {Q}_{1} \cdot \sum \cdot {Q}_{2}^{T} \qquad Eq . ( 6 )$$

$${K}^{′} = {Q}_{2} \cdot {\sum }^{+} \cdot {Q}_{1}^{T} \qquad Eq . ( 7 )$$

where Σ denotes the diagonal matrix consisting singular values in K, Σ⁺ denotes the diagonal matrix consisting of the reciprocals of the singular values in K. According to Eq. (6), a matrix factorization is performed on the original inverse transform kernel K by singular value decomposition (SVD), the original inverse transform kernel K is decomposed into three matrices: Q₁, Σ, and [symbol] . For example, Q₁ is an m×m orthogonal matrix, Σ is an m×n diagonal matrix with non-negative singular values on the diagonal, and · [symbol] is the transpose of a n×n orthogonal matrix. Then, the compensated inverse transform kernel K′ can be calculated according to Eq. (7).

In some aspects, during the decoding stage, a compensation offset (term) in the spatial domain can be separately computed from the original inverse transform. The compensation offset can be added to the reconstructed spatial blocks. In an example, an offset compensation matrix K is computed according to Eq. (8), an offset compensation matrix K_{c} is a matrix to derive the compensation offset for each position in integer domain. The reconstructed block can be represented by Eq. (9) in an example.

$${K}_{c} = int ( K \cdot ( \frac{{K}^{T} \cdot K}{{s}^{2}} - I ) ) \qquad Eq . ( 8 )$$

$$iX = {tX}_{q} \cdot K - {tX}_{q} \cdot {K}_{c} \qquad Eq . ( 9 )$$

In some examples, the reconstructed transform block can be further computed according to Eq. (9). For example, forward transform can be applied on iX using original forward transform kernel K^{T} to compute the reconstructed transform block.

In some examples, different (e.g., higher) precision can be used for computations of tX_{q}·K and tX_{q}·K_{c}.

In some examples, a scaled offset compensation matrix [symbol] is calculated by a scaling based on a scaling factor b during the derivation stage, such as Eq. (10), and then the reconstructed block (with the compensation offset) can be computed as Eq. (11):

$${K}_{c}^{*} = int ( bK \cdot ( \frac{{K}^{T} \cdot K}{{s}^{2}} - I ) ) \qquad Eq . ( 10 )$$

$$iX = {tX}_{q} \cdot K - int ( \frac{{tX}_{q} \cdot {K}_{c}^{*}}{b} ) \qquad Eq . ( 11 )$$

In another example, to eliminate the division, the scaling factor is set as b=2^{a}, which can reduce computation of Eq. (11), and convert Eq. (11) to Eq. (12):

$$iX = {tX}_{q} \cdot K - int ( ( {tX}_{q} \cdot {K}_{c}^{*} ) ≫ a ) \qquad Eq . ( 12 )$$

In some aspects, the compensation can be performed on spectrum coefficients, such as according to Eq. (13):

$${tX}^{′} = tX + tX \cdot int ( \frac{tX \cdot {K}_{c}^{*}}{b} ) \qquad Eq . ( 13 )$$

In some examples, the compensation can be performed at encoder side before the quantization, such as shown by Eq. (13). In some examples, compensation can be performed at the decoder side after the inverse quantization (also referred to as dequantization), such as shown by Eq. (14).

$${{tX}_{q}}^{′} = {tX}_{q} + {tX}_{q} \cdot int ( \frac{{tX}_{q} \cdot {K}_{c}^{*}}{b} ) \qquad Eq . ( 14 )$$

In some aspects, the transform kernel orthonormality (e.g., including orthogonality) compensation can be performed at the forward transform at the encoder side.

In some examples, the compensated inverse transform kernel K′ computed by Eq. (5) or Eqs. (6-7) can be used to further calculate compensated forward transform kernel K′T. Then, the forward transform at the encoder side can be X·K′T to compensate for the non-orthogonality at the encoder side. Further, the inverse transform (by decoder) can remain the same, for example using the original inverse transform kernel K.

In another example, when applying the compensation to forward transform, the orthonormality compensation offset is computed separately with higher precision. For example, a scaled offset compensation matrix K_{c}* is calculated by a scaling based on a scaling factor b during the derivation stage, such as Eq. (10). Then, the transform coefficients can be computed by Eq. (15):

$$X \cdot {K}^{T} - int ( \frac{X \cdot {K}_{c}^{* T}}{b} ) \qquad Eq . ( 15 )$$

In some examples, the scaling factor b is set to have a value of power of two, such as b=2^{a} (a is a positive integer), then the transform coefficients can be computed by Eq. (16):

$$X \cdot {K}^{T} - int ( ( X \cdot {K}_{c}^{* T} ) ≫ a ) \qquad Eq . ( 16 )$$

In some aspects, the compensation term can be distributed to both forward transform at the encoder side and inverse transform at the decoder side. For example, the compensation term is split into a first distribution at the encoder side, and a second distribution at the decoder side. The first distribution of the compensation term can be performed for example according to Eq. (15), and the second distribution of the compensation term can be performed for example according to Eq. (11).

In some aspects, the compensation offset (term) can be applied based on the information derived from the current TU and neighboring TUs. For example, when a compensation offset is performed for a neighboring TU, the compensation offset can be applied for the current TU.

In some aspects, the orthonormality compensation offset can be applied based on information signaled in a bitstream. For example, one or more syntax elements are signaled in the bitstream to indicate whether to apply the orthonormality compensation offset and/or configuration for applying the orthonormality compensation offset.

In an example, one bit can be used to indicate whether apply the orthonormality compensation offset for the current block/slice/frame/sequence.

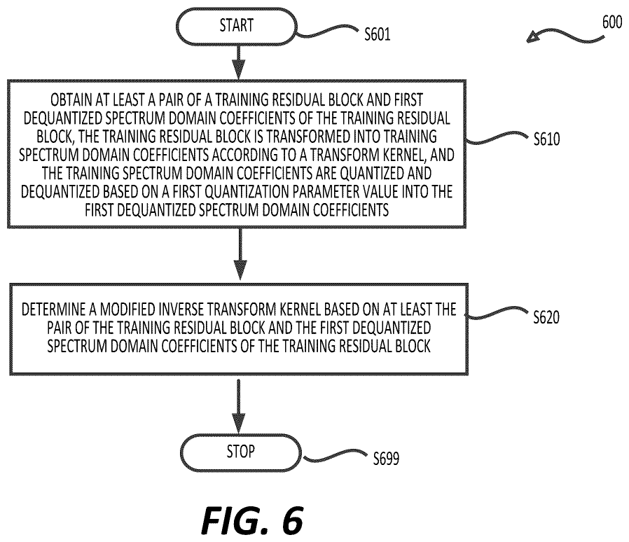

FIG. 6 shows a flow chart outlining a process (600) of learning an inverse transform kernel (also referred to as optimal inverse transform kernel, a modified inverse transform kernel in some examples) for quantization compensation according to an aspect of the disclosure. The process (600) can be used in any suitable information processing device. In an example, the process (600) is performed as offline training based on training video data. In another example, the process (600) is performed in an encoder for online training. For example, a first portion of a video is used as training data, and a pair of transform kernel and inverse transform kernel (also referred to as original transform kernel and original inverse transform kernel) can be used for transform and inverse transform of the first portion of the video. The first portion of the video is used to learn one or more modified inverse transform kernels to replace the original inverse transform kernel in encoding/decoding of other portions of the video after the first portion. In various aspects, the process (600) is executed by processing circuitry. In some aspects, the process (600) is implemented in software instructions, thus when the processing circuitry executes the software instructions, the processing circuitry performs the process (600). The process starts at (S601) and proceeds to (S610).

At (S610), at least a pair of a training residual block and first dequantized spectrum domain coefficients of the training residual block is obtained, the training residual block is transformed into training spectrum domain coefficients according to a transform kernel, and the training spectrum domain coefficients are quantized and dequantized based on a first quantization parameter value into the first dequantized spectrum domain coefficients.

At (S620), a modified inverse transform kernel is determined based on at least the pair of the training residual block and the first dequantized spectrum domain coefficients of the training residual block.

In some aspects, a plurality of pairs of training residual blocks and first dequantized spectrum domain coefficients are obtained from offline training data or online training data. The modified inverse transform kernel (or the modified transform kernel) is obtained for example by least square regression based on the plurality of pairs of training residual blocks and first dequantized spectrum domain coefficients, such as using Eq. (4).

In some examples, the modified inverse transform kernel (or the modified transform kernel) is determined by a least square regression. In some examples, the modified inverse transform kernel (or the modified transform kernel) is determined using a neural network. In some examples, the modified inverse transform kernel is determined using a probability distribution based method.

In some aspects, an inverse of the transform kernel is replaced with the modified inverse transform kernel during a reconstruction of a residual block when the transform kernel and the first quantization parameter value are applied on the residual block for transform and quantization.

In some aspects, an inverse of the transform kernel is replaced with the modified inverse transform kernel during a reconstruction of a residual block when the transform kernel and a second quantization parameter value are applied on the residual block for transform and quantization, a difference of the second quantization parameter value and the first quantization parameter value is in a pre-defined range.

In some examples, a quantization compensation matrix is determined based on the training spectrum domain coefficients, and the first dequantized spectrum domain coefficients for the training spectrum domain coefficients. The quantization compensation matrix is determined in the spectrum domain before inverse transform. The modified inverse transform kernel can be calculated as a dot product of the quantization compensation matrix and an inverse of the transform kernel.

In some examples, a quantization compensation matrix is determined based on the training residual block and a reconstructed residual block from the first dequantized spectrum domain coefficients according to an inverse transform using an inverse of the transform kernel. The quantization compensation matrix is determined in the spatial domain after inverse transform. The modified inverse transform kernel is calculated by a dot product of the inverse of the transform kernel and the quantization compensation matrix.

In some aspects, a compensation strength control function is derived by a fitting of a relationship of quantization parameter values and distribution changes between spectrum domain coefficients and quantized spectrum domain coefficients of training data.

In some aspects, when a second quantization parameter value is different from the first quantization parameter value, a compensation strength for the second quantization parameter value is determined, for example by the compensation strength control function. A second modified inverse transform kernel associated with the second quantization parameter can be determined based on the modified inverse transform kernel associated with the first quantization parameter value and the compensation strength.

In some examples, the inverse transform is split into a first dimension inverse transform and a second dimension inverse transform. A first dimension quantization compensation is determined after applying the first dimension inverse transform on the first dequantized spectrum domain coefficients. A second dimension quantization compensation is determined after applying the second dimension inverse transform.

In some aspects, to apply the modified inverse transform kernel on a block is determined when at least one of a block shape of the block and a block size of the block satisfies a requirement.

In some aspects, the training residual block is in a first portion of a video that is reconstructed based on the inverse of the transform kernel, and the modified inverse transform kernel is applied for a reconstruction of a residual block in a second portion of the video.

Then, the process proceeds to (S699) and terminates.

The process (600) can be suitably adapted. Step(s) in the process (600) can be modified and/or omitted. Additional step(s) can be added. Any suitable order of implementation can be used.

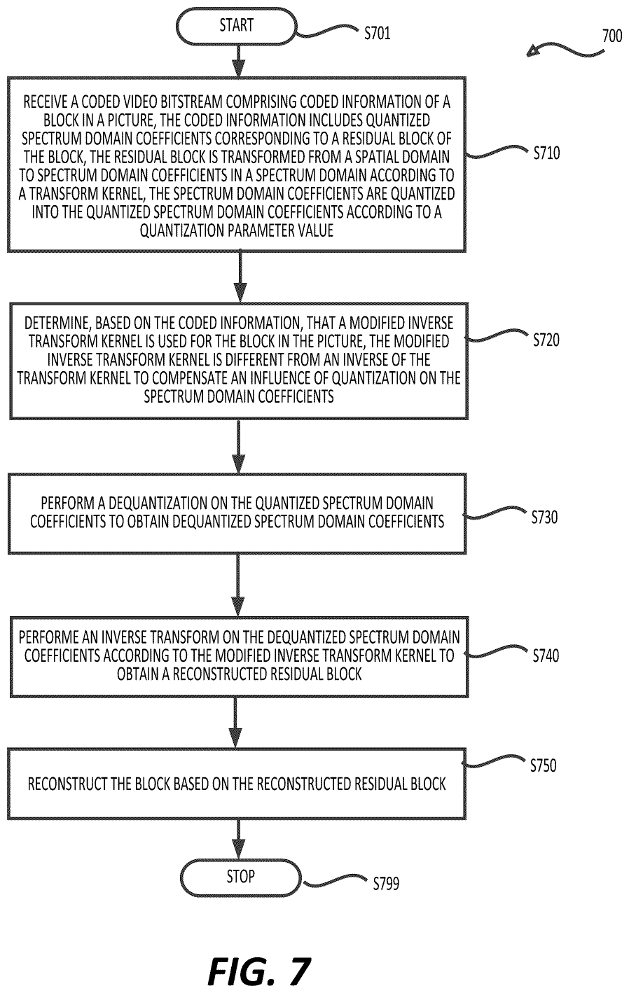

FIG. 7 shows a flow chart outlining a process (700) according to an aspect of the disclosure. The process (700) can be used in a video decoder. In various aspects, the process (700) is executed by processing circuitry, such as the processing circuitry that performs functions of the video decoder (110), the processing circuitry that performs functions of the video decoder (210), and the like. In some aspects, the process (700) is implemented in software instructions, thus when the processing circuitry executes the software instructions, the processing circuitry performs the process (700). The process starts at (S701) and proceeds to (S710).

At (S710), a coded video bitstream is received. The coded video bitstream includes coded information of a block in a picture, the coded information includes quantized spectrum domain coefficients corresponding to a residual block of the block, the residual block is transformed from a spatial domain to spectrum domain coefficients in a spectrum domain according to a transform kernel, the spectrum domain coefficients are quantized into the quantized spectrum domain coefficients according to a quantization parameter value.

At (S720), based on the coded information, a modified inverse transform kernel is determined to be used for the block in the picture, the modified inverse transform kernel is different from an inverse of the transform kernel to compensate an influence of quantization on the spectrum domain coefficients.

At (S730), a dequantization is performed on the quantized spectrum domain coefficients to obtain dequantized spectrum domain coefficients.

At (S740), an inverse transform is performed on the dequantized spectrum domain coefficients according to the modified inverse transform kernel to obtain a reconstructed residual block.

At (S750), the block is reconstructed based on the reconstructed residual block.

In some aspects, the modified inverse transform kernel is selected from a plurality of modified inverse transform kernels according to the quantization parameter value of the block, the plurality of modified inverse transform kernels respectively correspond to different quantization parameter values.

In some examples, the quantization parameter value of the block is within a range to a specific quantization parameter value associated with the modified inverse transform kernel.

In some examples, the modified inverse transform kernel comprises a quantization compensation matrix, a dot product of the quantization compensation matrix with an inverse of the transform kernel corresponds to the modified inverse transform kernel.

In some aspects, a compensation strength is determined according to the quantization parameter value of the block and a specific quantization parameter value associated with a pre-learned inverse transform kernel. The modified inverse transform kernel is determined according to the compensation strength and the pre-learned inverse transform kernel associated with the specific quantization parameter value.

In some aspects, the modified inverse transform kernel is determined to be used for the block when at least one of a block shape of the block and a block size of the block satisfies a requirement.

In some examples, the block is in a second portion of a video that is coded in the coded video bitstream after a first portion of the video, the modified inverse transform kernel is learned based on the first portion of the video. In an example, at least a syntax element is decoded from the coded video bitstream, the syntax element indicates a switch from the inverse of the transform kernel to the modified inverse transform kernel.

In an example, values in the modified inverse transform kernel are decoded from the coded video bitstream.

In some examples, the modified inverse transform kernel is stored in association with the transform kernel, the modified inverse transform kernel is pre-learned for the transform kernel. In an example, the transform kernel is a primary transform kernel. In another example, the transform kernel is a secondary transform kernel. In another example, the transform kernel includes both a primary transform kernel and a secondary transform kernel.

In some examples, a plurality of modified inverse transform kernels are stored in association with the transform kernel, the plurality of modified inverse transform kernels are pre-learned for different quantization parameter values. In an example, the transform kernel is a primary transform kernel. In another example, the transform kernel is a secondary transform kernel. In another example, the transform kernel includes both a primary transform kernel and a secondary transform kernel.

Then, the process proceeds to (S799) and terminates.

The process (700) can be suitably adapted. Step(s) in the process (700) can be modified and/or omitted. Additional step(s) can be added. Any suitable order of implementation can be used.

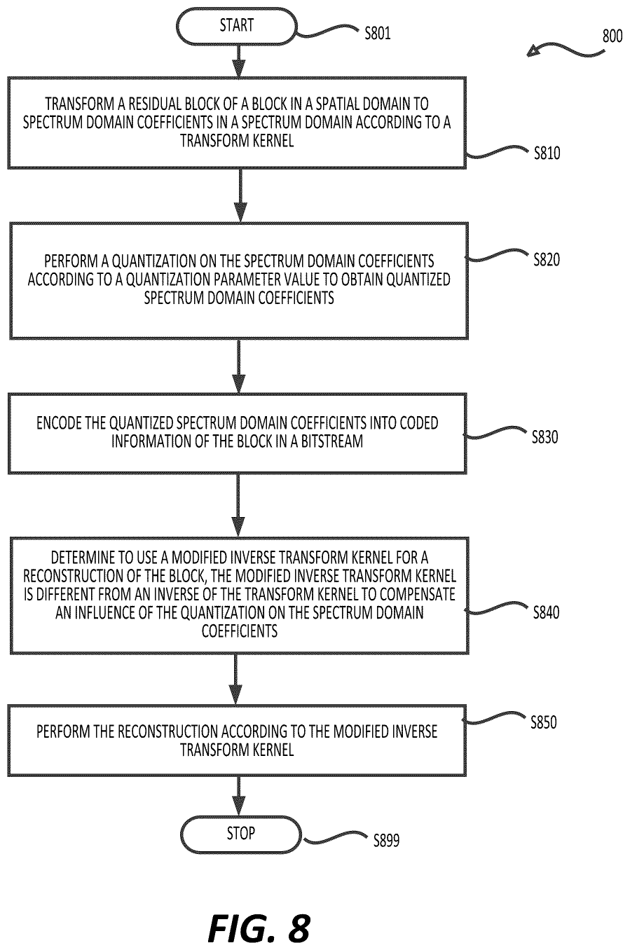

FIG. 8 shows a flow chart outlining a process (800) according to an aspect of the disclosure. The process (800) can be used in a video encoder. In various aspects, the process (800) is executed by processing circuitry, such as the processing circuitry that performs functions of the video encoder (103), the processing circuitry that performs functions of the video encoder (303), and the like. In some aspects, the process (800) is implemented in software instructions, thus when the processing circuitry executes the software instructions, the processing circuitry performs the process (800). The process starts at (S801) and proceeds to (S810).

At (S810), a residual block of a block in a spatial domain is transform to spectrum domain coefficients in a spectrum domain according to a transform kernel.

At (S820), a quantization is performed on the spectrum domain coefficients according to a quantization parameter value to obtain quantized spectrum domain coefficients.

At (S830), the quantized spectrum domain coefficients are encoded into coded information of the block in a bitstream.

At (S840), to use a modified inverse transform kernel for a reconstruction of the block is determined. The modified inverse transform kernel is different from an inverse of the transform kernel to compensate an influence of the quantization on the spectrum domain coefficients.

At (S850), the reconstruction is performed according to the modified inverse transform kernel.

In some examples, the modified inverse transform kernel is selected from a plurality of modified inverse transform kernels according to the quantization parameter value of the block, the plurality of modified inverse transform kernels respectively correspond to different quantization parameter values.

In some examples, the quantization parameter value of the block is within a range to a specific quantization parameter value associated with the modified inverse transform kernel.

In some aspects, the modified inverse transform kernel comprises a quantization compensation matrix, a dot product of the quantization compensation matrix with an inverse of the transform kernel corresponds to the modified inverse transform kernel.

In some aspects, a compensation strength is determined according to the quantization parameter value of the block and a specific quantization parameter value associated with a pre-learned inverse transform kernel. The modified inverse transform kernel is calculated according to the compensation strength and the pre-learned inverse transform kernel associated with the specific quantization parameter value.

In some aspects, to use the modified inverse transform kernel for the block is determined when at least one of a block shape of the block and a block size of the block satisfies a requirement.

In some aspects, the block is in a second portion of a video that is coded into the bitstream after a first portion of the video, the modified inverse transform kernel is learned based on the first portion of the video. In some examples, the modified inverse transform kernel is learned according to the first portion of the video; and at least a syntax element is included into the bitstream, the syntax element indicates a switch from the inverse of the transform kernel to the modified inverse transform kernel. In some examples, values in the modified inverse transform kernel are suitably encoded into the bitstream.

In some aspects, the modified inverse transform kernel is stored in association with the transform kernel, the modified inverse transform kernel is pre-learned for the transform kernel. In an example, the transform kernel is a primary transform kernel. In another example, the transform kernel is a secondary transform kernel. In another example, the transform kernel includes both a primary transform kernel and a secondary transform kernel.

In some examples, a plurality of modified inverse transform kernels are stored in association with the transform kernel, the plurality of modified inverse transform kernels are pre-learned for different quantization parameter values. In an example, the transform kernel is a primary transform kernel. In another example, the transform kernel is a secondary transform kernel. In another example, the transform kernel includes both a primary transform kernel and a secondary transform kernel.

Then, the process proceeds to (S899) and terminates.

The process (800) can be suitably adapted. Step(s) in the process (800) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a block in a picture, the coded information includes quantized spectrum domain coefficients corresponding to a residual block of the block, the residual block is transformed from a spatial domain to spectrum domain coefficients in a spectrum domain according to a transform kernel, the spectrum domain coefficients are quantized into the quantized spectrum domain coefficients according to a quantization parameter value. The format rule specifies that: based on the coded information, to use a modified inverse transform kernel for the block in the picture is determined, the modified inverse transform kernel is different from an inverse of the transform kernel to compensate an influence of quantization on the spectrum domain coefficients. The format rule also specifies that dequantization is performed on the quantized spectrum domain coefficients to obtain dequantized spectrum domain coefficients; an inverse transform is performed on the dequantized spectrum domain coefficients according to the modified inverse transform kernel to obtain a reconstructed residual block; and the block is reconstructed based on the reconstructed residual block.

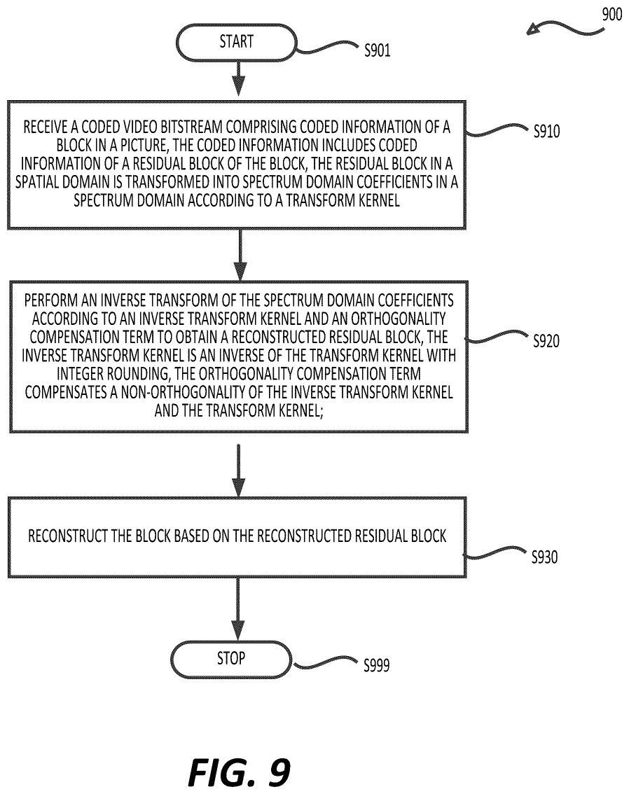

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream is received. The coded video bitstream includes coded information of a block in a picture, the coded information includes coded information of spectrum domain coefficients corresponding to a residual block of the block, the residual block in a spatial domain is transformed into the spectrum domain coefficients in a spectrum domain according to a transform kernel.

At (S920), an inverse transform is performed on the spectrum domain coefficients according to an inverse transform kernel and an orthogonality compensation term to obtain a reconstructed residual block, the inverse transform kernel is an inverse of the transform kernel with integer rounding, the orthogonality compensation term compensates a non-orthogonality of the inverse transform kernel and the transform kernel.

At (S930), the block is reconstructed based on the reconstructed residual block.

In some aspects, the inverse transform of the spectrum domain coefficients is performed according to a modified inverse transform kernel that embeds the orthogonality compensation term, the modified inverse transform kernel is calculated based on the inverse transform kernel and the transform kernel.

In some aspects, the inverse transform of the spectrum domain coefficients is performed according to a modified inverse transform kernel that embeds the orthogonality compensation term, the modified inverse transform kernel is calculated based on a singular value decomposition (SVD) of one of the inverse transform kernel and the transform kernel.

In some aspects, to perform the inverse transform, a first inverse transform of the spectrum domain coefficients is performed according to the inverse transform kernel to obtain a first portion of the reconstructed residual block and a second inverse transform of the spectrum domain coefficients is performed according to the orthogonality compensation term to obtain a compensation offset in the spatial domain. The first portion of the reconstructed residual block is combined with the compensation offset in the spatial domain to obtain the reconstructed residual block.

In some examples, the first inverse transform and the second inverse transform are performed with different precisions. For example, to perform the second inverse transform, during a calculation of the orthogonality compensation term, a scaling up is performed by a scaling factor to obtain a scaled orthogonality compensation term, the scaled orthogonality compensation term is calculated based on the transform kernel and the inverse transform kernel. The second inverse transform of the spectrum domain coefficients is performed according to the scaled orthogonality compensation term to obtain a scaled compensation offset in the spatial domain; and the scaled compensation offset in the spatial domain is scaled down to obtain the compensation offset. In an example, the scaling factor is a value of a power of two.

In some aspects, to perform the inverse transform, compensated spectrum domain coefficients are obtained, the compensated spectrum domain coefficients are compensated based on the orthogonality compensation term in the spectrum domain. The inverse transform is performed on the compensated spectrum domain coefficients according to the inverse transform kernel to obtain the reconstructed residual block.

In an example, the compensated spectrum domain coefficients are obtained from the coded information of the block. The compensated spectrum domain coefficients are calculated at the encoder side (e.g., by compensation of the forward transform), and encoded into the coded information of the block.

In another example, the compensated spectrum domain coefficients are calculated at the decoder side based on the orthogonality compensation term and the spectrum domain coefficients (decoded from the coded information of the block).

In another example, the orthogonality compensation term is distributed at the encoder side and the decoder side. For example, semi-compensated spectrum domain coefficients are decoded from the coded information of the block, the semi-compensated spectrum domain coefficients are compensated based on a first distribution of the orthogonality compensation term on the forward transform at the encoder side. The compensated spectrum domain coefficients are calculated based on a second distribution of the orthogonality compensation term on the inverse transform at the decoder side and the semi-compensated spectrum domain coefficients.

In some aspects, to apply the orthogonality compensation term on the block is determined when a transform block (TU) formed of the spectrum domain coefficients of the block satisfies a requirement; or a neighboring TU of the block satisfies a requirement.

In some aspects, whether to apply the orthogonality compensation term on the block based on a syntax element in the coded video bitstream. The syntax element is a one-bit flag that is signaled at least in one of a sequence parameter set (SPS), a picture parameter set (PPS), a slice header, a picture header, a coding tree unit (CTU) level, and a block level.

Then, the process proceeds to (S999) and terminates.

The process (900) can be suitably adapted. Step(s) in the process (900) can be modified and/or omitted. Additional step(s) can be added. Any suitable order of implementation can be used.

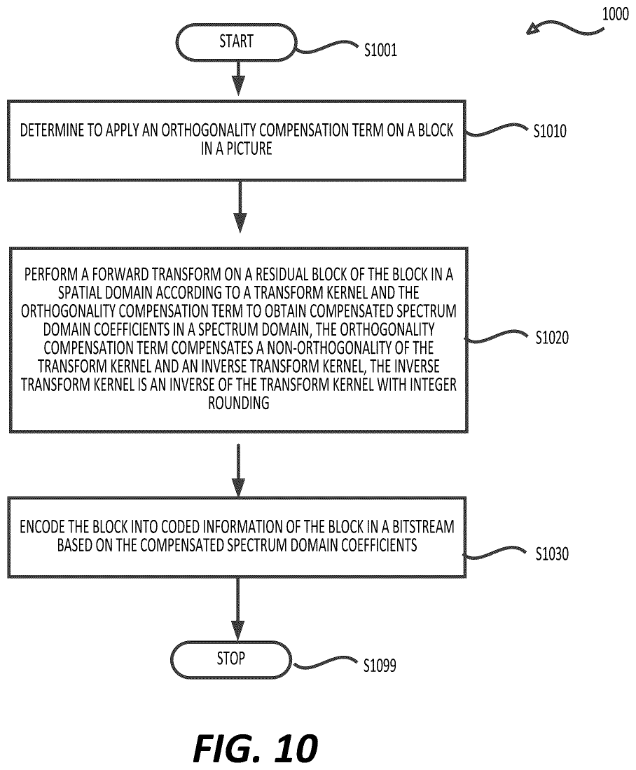

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), to apply an orthogonality compensation term on a block in a picture is determined.

At (S1020), a forward transform is performed on a residual block of the block in a spatial domain according to a transform kernel and the orthogonality compensation term to obtain compensated spectrum domain coefficients in a spectrum domain. The orthogonality compensation term compensates a non-orthogonality of the transform kernel and an inverse transform kernel, the inverse transform kernel is an inverse of the transform kernel with integer rounding.

At (S1030), the block is encoded into coded information of the block in a bitstream based on the compensated spectrum domain coefficients.

In some aspects, the forward transform is performed on the residual block according to a modified transform kernel that embeds the orthogonality compensation term, the modified transform kernel is calculated based on the inverse transform kernel and the transform kernel.

In some aspects, the forward transform is performed on the residual block according to a modified transform kernel that embeds the orthogonality compensation term, the modified transform kernel is calculated based on a singular value decomposition (SVD) of one of the inverse transform kernel and the transform kernel.

In some aspects, to perform the forward transform, in an example, a first transform (e.g., first forward transform) is performed on the residual block according to the transform kernel to obtain a first portion of the compensated spectrum domain coefficients. A second transform is performed on the residual block according to the orthogonality compensation term to obtain a compensation offset in the spectrum domain. The first portion of the compensated spectrum domain coefficients is combined with the compensation offset in the spectrum domain to obtain the compensated spectrum domain coefficients.

In some examples, the first transform and the second transform are performed with different precisions. In an example, during a calculation of the orthogonality compensation term, a scaling up is performed by a scaling factor to obtain a scaled orthogonality compensation term, the scaled orthogonality compensation term is calculated based on the transform kernel and the inverse transform kernel. The second transform of the residual block is performed according to the scaled orthogonality compensation term to obtain a scaled compensation offset in the spectrum domain. The scaled compensation offset in the spectrum domain is scaled down to obtain the compensation offset. In an example, the scaling factor is a value of a power of two.

In some examples, semi-compensated spectrum domain coefficients are calculated based on a first distribution of the orthogonality compensation term at the encoder side. The semi-compensated spectrum domain coefficients are encoded into the bitstream. The semi-compensated spectrum domain coefficients can be further compensated according to a second distribution of the orthogonality compensation term at the decoder side.

In some examples, to apply the orthogonality compensation term on the block is determined when a transform block (TU) formed of spectrum domain coefficients of the block satisfies a requirement. In another example, to apply the orthogonality compensation term on the block is determined when a neighboring TU of the block satisfies a requirement.

In some aspects, a syntax element is encoded in the bitstream to indicate to apply at least a portion of the orthogonality compensation term on a decoder side. The syntax element is one-bit flag that is signaled at least in one of a sequence parameter set (SPS), a picture parameter set (PPS), a slice header, a picture header, a coding tree unit (CTU) level, and a block level.

Then, the process proceeds to (S1099) and terminates.

The process (1000) can be suitably adapted. Step(s) in the process (1000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a block in a picture, the coded information includes coded information of spectrum domain coefficients corresponding to a residual block of the block, the residual block in a spatial domain is transformed into the spectrum domain coefficients in a spectrum domain according to a transform kernel. The format rule specifies that an inverse transform of the spectrum domain coefficients is performed according to an inverse transform kernel and an orthogonality compensation term to obtain a reconstructed residual block, the inverse transform kernel is an inverse of the transform kernel with integer rounding, the orthogonality compensation term compensates a non-orthogonality of the inverse transform kernel and the transform kernel. The block is reconstructed based on the reconstructed residual block.

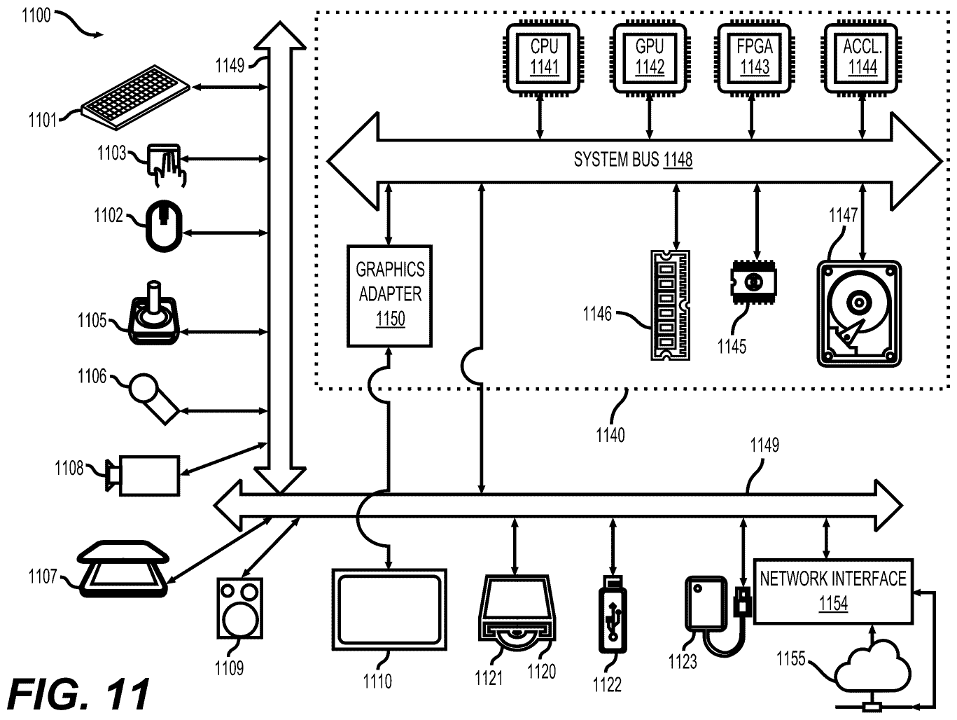

The techniques described above, can be implemented as computer software using computer-readable instructions and physically stored in one or more computer-readable media. For example, FIG. 11 shows a computer system (1100) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various aspects of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of quantization compensation, including: obtaining at least a pair of a training residual block and first dequantized spectrum domain coefficients of the training residual block, the training residual block being transformed into training spectrum domain coefficients according to a transform kernel, and the training spectrum domain coefficients being quantized and dequantized based on a first quantization parameter value into the first dequantized spectrum domain coefficients; and determining a modified inverse transform kernel for an inverse transform based on at least the pair of the training residual block and the first dequantized spectrum domain coefficients of the training residual block.

(2). The method of feature (1), in which the determining the modified inverse transform kernel includes at least one of: determining the modified inverse transform kernel by a least square regression; determining the modified inverse transform kernel using a neural network; and/or determining the modified inverse transform kernel using a probability distribution based method.

(3). The method of any of features (1) to (2), further including: replacing an inverse of the transform kernel with the modified inverse transform kernel during a reconstruction of a residual block when the transform kernel and the first quantization parameter value are applied on the residual block for transform and quantization.

(4). The method of any of features (1) to (3), further including: replacing an inverse of the transform kernel with the modified inverse transform kernel during a reconstruction of a residual block when the transform kernel and a second quantization parameter value are applied on the residual block for transform and quantization, a difference of the second quantization parameter value and the first quantization parameter value being in a pre-defined range.

(5). The method of any of features (1) to (4), further including: determining a quantization compensation matrix based on the training spectrum domain coefficients, and the first dequantized spectrum domain coefficients for the training spectrum domain coefficients; and calculating the modified inverse transform kernel by a dot product of the quantization compensation matrix and an inverse of the transform kernel.

(6). The method of any of features (1) to (5), further including: determining a quantization compensation matrix based on the training residual block and a reconstructed residual block from the first dequantized spectrum domain coefficients according to an inverse transform using an inverse of the transform kernel; and calculating the modified inverse transform kernel by a dot product of the inverse of the transform kernel and the quantization compensation matrix.

(7). The method of any of features (1) to (6), further including: deriving a compensation strength control function by a fitting of a relationship of quantization parameter values and distribution changes between spectrum domain coefficients and quantized spectrum domain coefficients of training data.

(8). The method of any of features (1) to (7), further including: determining a compensation strength for a second quantization parameter value according to the compensation strength control function when the second quantization parameter value is different from the first quantization parameter value; and determining a second modified inverse transform kernel based on the modified inverse transform kernel associated with the first quantization parameter value and the compensation strength.

(9). The method of any of features (1) to (8), in which the inverse transform includes a first dimension inverse transform and a second dimension inverse transform, and the method includes: determining a first dimension quantization compensation after applying the first dimension inverse transform on the first dequantized spectrum domain coefficients; and determining a second dimension quantization compensation after applying the second dimension inverse transform.

(10). The method of any of features (1) to (9), further including: determining to apply the modified inverse transform kernel on a block when at least one of a block shape of the block and a block size of the block satisfies a requirement.

(11). The method of any of features (1) to (10), in which the training residual block is in a first portion of a video that is reconstructed based on an inverse of the transform kernel, and the modified inverse transform kernel is applied for a reconstruction of a residual block in a second portion of the video.

(12). A method of video decoding, including: receiving a coded video bitstream including coded information of a block in a picture, the coded information including quantized spectrum domain coefficients corresponding to a residual block of the block, the residual block being transformed from a spatial domain to spectrum domain coefficients in a spectrum domain according to a transform kernel, the spectrum domain coefficients being quantized into the quantized spectrum domain coefficients according to a quantization parameter value; determining, based on the coded information, that a modified inverse transform kernel is used for the block in the picture, the modified inverse transform kernel being different from an inverse of the transform kernel to compensate an influence of quantization on the spectrum domain coefficients; performing a dequantization on the quantized spectrum domain coefficients to obtain dequantized spectrum domain coefficients; performing an inverse transform on the dequantized spectrum domain coefficients according to the modified inverse transform kernel to obtain a reconstructed residual block; and reconstructing the block based on the reconstructed residual block.

(13). The method of feature (12), further including: selecting the modified inverse transform kernel from a plurality of modified inverse transform kernels according to the quantization parameter value of the block, the plurality of modified inverse transform kernels respectively corresponding to different quantization parameter values.

(14). The method of any of features (12) to (13), in which the quantization parameter value of the block is within a range to a specific quantization parameter value associated with the modified inverse transform kernel.

(15). The method of any of features (12) to (14), in which the modified inverse transform kernel includes a quantization compensation matrix, a dot product of the quantization compensation matrix with an inverse of the transform kernel corresponds to the modified inverse transform kernel.

(16). The method of any of features (12) to (15), further including: determining a compensation strength according to the quantization parameter value of the block and a specific quantization parameter value associated with a pre-learned inverse transform kernel; and calculating the modified inverse transform kernel according to the compensation strength and the pre-learned inverse transform kernel associated with the specific quantization parameter value.

(17). The method of any of features (12) to (16), in which the determining includes: determining that the modified inverse transform kernel is used for the block when at least one of a block shape of the block and a block size of the block satisfies a requirement.

(18). The method of any of features (12) to (17), in which the block is in a second portion of a video that is coded in the coded video bitstream after a first portion of the video, the modified inverse transform kernel is learned based on the first portion of the video, the method includes: decoding at least a syntax element from the coded video bitstream, the syntax element indicating a switch from the inverse of the transform kernel to the modified inverse transform kernel.

(19). The method of any of features (12) to (18), further including: decoding values in the modified inverse transform kernel from the coded video bitstream.

(20). The method of any of features (12) to (19), further including: storing the modified inverse transform kernel in association with the transform kernel, the modified inverse transform kernel being pre-learned for the transform kernel, the transform kernel including at least one of a primary transform kernel and/or a secondary transform kernel.

(21). A method of video encoding, including: transforming a residual block of a block in a spatial domain to spectrum domain coefficients in a spectrum domain according to a transform kernel; performing a quantization on the spectrum domain coefficients according to a quantization parameter value to obtain quantized spectrum domain coefficients; encoding the quantized spectrum domain coefficients into coded information of the block in a bitstream; determining to use a modified inverse transform kernel for a reconstruction of the block, the modified inverse transform kernel being different from an inverse of the transform kernel to compensate an influence of the quantization on the spectrum domain coefficients; and performing the reconstruction according to the modified inverse transform kernel.

(22). The method of feature (21), further including: selecting the modified inverse transform kernel from a plurality of modified inverse transform kernels according to the quantization parameter value of the block, the plurality of modified inverse transform kernels respectively corresponding to different quantization parameter values.

(23). The method of any of features (21) to (22), in which the quantization parameter value of the block is within a range to a specific quantization parameter value associated with the modified inverse transform kernel.

(24). The method of any of features (21) to (23), in which the modified inverse transform kernel includes a quantization compensation matrix, a dot product of the quantization compensation matrix with an inverse of the transform kernel corresponds to the modified inverse transform kernel.

(25). The method of any of features (21) to (24), further including: determining a compensation strength according to the quantization parameter value of the block and a specific quantization parameter value associated with a pre-learned inverse transform kernel; and calculating the modified inverse transform kernel according to the compensation strength and the pre-learned inverse transform kernel associated with the specific quantization parameter value.

(26). The method of any of features (21) to (25), in which the determining includes: determining to use the modified inverse transform kernel for the block when at least one of a block shape of the block and a block size of the block satisfies a requirement.

(27). The method of any of features (21) to (26), in which the block is in a second portion of a video that is coded into the bitstream after a first portion of the video, the modified inverse transform kernel is learned based on the first portion of the video, the method includes: determining the modified inverse transform kernel by a learning according to the first portion of the video; and including at least a syntax element into the bitstream, the syntax element indicating a switch from the inverse of the transform kernel to the modified inverse transform kernel.

(28). The method of any of features (21) to (27), further including: encoding values in the modified inverse transform kernel into the bitstream.

(29). The method of any of features (21) to (28), further including: storing the modified inverse transform kernel in association with the transform kernel, the modified inverse transform kernel being pre-learned for the transform kernel, the transform kernel including at least one of a primary transform kernel and/or a secondary transform kernel.

(30). A method of processing visual media data, the method including: processing a bitstream that includes the visual media data according to a format rule, in which: the bitstream carries coded information of a block in a picture, the coded information including quantized spectrum domain coefficients corresponding to a residual block of the block, the residual block being transformed from a spatial domain to spectrum domain coefficients in a spectrum domain according to a transform kernel, the spectrum domain coefficients being quantized into the quantized spectrum domain coefficients according to a quantization parameter value; and the format rule specifies that: based on the coded information, to use a modified inverse transform kernel for the block in the picture is determined, the modified inverse transform kernel being different from an inverse of the transform kernel to compensate an influence of quantization on the spectrum domain coefficients; a dequantization is performed on the quantized spectrum domain coefficients to obtain dequantized spectrum domain coefficients; an inverse transform is performed on the dequantized spectrum domain coefficients according to the modified inverse transform kernel to obtain a reconstructed residual block; and the block is reconstructed based on the reconstructed residual block.

(31). A method of video decoding, including: receiving a coded video bitstream including coded information of a block in a picture, the coded information including coded information of spectrum domain coefficients corresponding to a residual block of the block, the residual block in a spatial domain being transformed into the spectrum domain coefficients in a spectrum domain according to a transform kernel; performing an inverse transform of the spectrum domain coefficients according to an inverse transform kernel and an orthogonality compensation term to obtain a reconstructed residual block, the inverse transform kernel being an inverse of the transform kernel with integer rounding, the orthogonality compensation term compensating a non-orthogonality of the inverse transform kernel and the transform kernel; and reconstructing the block based on the reconstructed residual block.

(32). The method of feature (31), in which the performing the inverse transform includes: performing the inverse transform of the spectrum domain coefficients according to a modified inverse transform kernel that embeds the orthogonality compensation term, the modified inverse transform kernel being calculated based on the inverse transform kernel and the transform kernel.

(33). The method of any of features (31) to (32), in which the performing the inverse transform includes: performing the inverse transform of the spectrum domain coefficients according to a modified inverse transform kernel that embeds the orthogonality compensation term, the modified inverse transform kernel being calculated based on a singular value decomposition (SVD) of one of the inverse transform kernel and the transform kernel.

(34). The method of any of features (31) to (33), in which the performing the inverse transform includes: performing a first inverse transform of the spectrum domain coefficients according to the inverse transform kernel to obtain a first portion of the reconstructed residual block; performing a second inverse transform of the spectrum domain coefficients according to the orthogonality compensation term to obtain a compensation offset in the spatial domain; and combining the first portion of the reconstructed residual block with the compensation offset in the spatial domain to obtain the reconstructed residual block.

(35). The method of any of features (31) to (34), in which the first inverse transform and the second inverse transform are performed with different precisions.

(36). The method of any of features (31) to (35), in which the performing the second inverse transform includes: scaling up, during a calculation of the orthogonality compensation term, by a scaling factor to obtain a scaled orthogonality compensation term, the scaled orthogonality compensation term being calculated based on the transform kernel and the inverse transform kernel; performing the second inverse transform of the spectrum domain coefficients according to the scaled orthogonality compensation term to obtain a scaled compensation offset in the spatial domain; and scaling down the scaled compensation offset in the spatial domain to obtain the compensation offset.

(37). The method of any of features (31) to (36), in which the scaling factor is a value of a power of two.

(38). The method of any of features (31) to (37), in which the performing the inverse transform includes: obtaining compensated spectrum domain coefficients, the compensated spectrum domain coefficients being compensated based on the orthogonality compensation term; and performing the inverse transform of the compensated spectrum domain coefficients according to the inverse transform kernel to obtain the reconstructed residual block.

(39). The method of any of features (31) to (38), in which the obtaining includes at least one of: obtaining the compensated spectrum domain coefficients from the coded information of the block; and calculating the compensated spectrum domain coefficients based on the orthogonality compensation term and the spectrum domain coefficients.

(40). The method of any of features (31) to (39), in which the obtaining includes: obtaining semi-compensated spectrum domain coefficients from the coded information of the block, the semi-compensated spectrum domain coefficients being compensated based on a first distribution of the orthogonality compensation term; and calculating the compensated spectrum domain coefficients based on a second distribution of the orthogonality compensation term and the semi-compensated spectrum domain coefficients.

(41). The method of any of features (31) to (40), further including: determining to apply the orthogonality compensation term on the block when: a transform block (TU) formed of the spectrum domain coefficients of the block satisfies a requirement; or a neighboring TU of the block satisfies a requirement.

(42). The method of any of features (31) to (41), further including: determining to apply the orthogonality compensation term on the block based on a syntax element in the coded video bitstream.

(43). The method of any of features (31) to (42), in which the syntax element is a one-bit flag that is signaled at least in one of a sequence parameter set (SPS), a picture parameter set (PPS), a slice header, a picture header, a coding tree unit (CTU) level, and a block level.

(44). A method of video encoding, including: determining to apply an orthogonality compensation term on a block in a picture; performing a forward transform on a residual block of the block in a spatial domain according to a transform kernel and the orthogonality compensation term to obtain compensated spectrum domain coefficients in a spectrum domain, the orthogonality compensation term compensating a non-orthogonality of the transform kernel and an inverse transform kernel, the inverse transform kernel being an inverse of the transform kernel with integer rounding; and encoding the block into coded information of the block in a bitstream based on the compensated spectrum domain coefficients.

(45). The method of feature (44), in which the performing the forward transform includes: performing the forward transform on the residual block according to a modified transform kernel that embeds the orthogonality compensation term, the modified transform kernel being calculated based on the inverse transform kernel and the transform kernel.

(46). The method of any of features (44) to (45), in which the performing the forward transform includes: performing the forward transform on the residual block according to a modified transform kernel that embeds the orthogonality compensation term, the modified transform kernel being calculated based on a singular value decomposition (SVD) of one of the inverse transform kernel and the transform kernel.

(47). The method of any of features (44) to (46), in which the performing the forward transform includes: performing a first transform on the residual block according to the transform kernel to obtain a first portion of the compensated spectrum domain coefficients; performing a second transform of the residual block according to the orthogonality compensation term to obtain a compensation offset in the spectrum domain; and combining the first portion of the compensated spectrum domain coefficients with the compensation offset in the spectrum domain to obtain the compensated spectrum domain coefficients.

(48). The method of any of features (44) to (47), in which the first transform and the second transform are performed with different precisions.

(49). The method of any of features (44) to (48), in which the performing the second transform includes: scaling up, during a calculation of the orthogonality compensation term, by a scaling factor to obtain a scaled orthogonality compensation term, the scaled orthogonality compensation term being calculated based on the transform kernel and the inverse transform kernel; performing the second transform of the residual block according to the scaled orthogonality compensation term to obtain a scaled compensation offset in the spectrum domain; and scaling down the scaled compensation offset in the spectrum domain to obtain the compensation offset.

(50). The method of any of features (44) to (49), in which the scaling factor is a value of a power of two.

(51). The method of any of features (44) to (50), in which the performing the forward transform includes: calculating semi-compensated spectrum domain coefficients based on a first distribution of the orthogonality compensation term; and encoding the semi-compensated spectrum domain coefficients into the bitstream.

(52). The method of any of features (44) to (51), further including: determining to apply the orthogonality compensation term on the block when: a transform block (TU) formed of spectrum domain coefficients of the block satisfies a requirement; or a neighboring TU of the block satisfies a requirement.

(53). The method of any of features (44) to (52), further including: encoding a syntax element in the bitstream to indicate to apply at least a portion of the orthogonality compensation term on a decoder side.

(54). The method of any of features (44) to (53), in which the syntax element is one-bit flag that is signaled at least in one of a sequence parameter set (SPS), a picture parameter set (PPS), a slice header, a picture header, a coding tree unit (CTU) level, and a block level.

(55). A method of processing visual media data, the method including: processing a bitstream that includes the visual media data according to a format rule, in which: the bitstream carries coded information of a block in a picture, the coded information including coded information of spectrum domain coefficients corresponding to a residual block of the block, the residual block in a spatial domain being transformed into the spectrum domain coefficients in a spectrum domain according to a transform kernel; and the format rule specifies that: an inverse transform of the spectrum domain coefficients is performed according to an inverse transform kernel and an orthogonality compensation term to obtain a reconstructed residual block, the inverse transform kernel being an inverse of the transform kernel with integer rounding, the orthogonality compensation term compensating a non-orthogonality of the inverse transform kernel and the transform kernel; and the block is reconstructed based on the reconstructed residual block.

(56). An apparatus of quantization compensation, including processing circuitry that is configured to perform the method of any of features (1) to (11).

(57). An apparatus for video decoding, including processing circuitry that is configured to perform the method of any of features (12) to (20).

(58). An apparatus for video encoding, including processing circuitry that is configured to perform the method of any of features (21) to (29).

(59). An apparatus for video decoding, including processing circuitry that is configured to perform the method of any of features (31) to (43).

(60). An apparatus for video encoding, including processing circuitry that is configured to perform the method of any of features (44) to (54).

(61). A non-transitory computer-readable storage medium storing instructions which when executed by at least one processor cause the at least one processor to perform the method of any of features (1) to (55).

What is claimed is:

1. A method of video decoding, comprising:
receiving a coded video bitstream comprising coded information of a block in a picture, the coded information including quantized spectrum domain coefficients corresponding to a residual block of the block, the residual block being transformed from a spatial domain to spectrum domain coefficients in a spectrum domain according to a transform kernel, the spectrum domain coefficients being quantized into the quantized spectrum domain coefficients according to a quantization parameter value;
determining, based on the coded information, that a modified inverse transform kernel is used for the block in the picture, the modified inverse transform kernel being different from an inverse of the transform kernel to compensate an influence of quantization on the spectrum domain coefficients;
performing a dequantization on the quantized spectrum domain coefficients to obtain dequantized spectrum domain coefficients;
performing an inverse transform on the dequantized spectrum domain coefficients according to the modified inverse transform kernel to obtain a reconstructed residual block; and
reconstructing the block based on the reconstructed residual block.

2. The method of claim 1, further comprising:
selecting the modified inverse transform kernel from a plurality of modified inverse transform kernels according to the quantization parameter value of the block, the plurality of modified inverse transform kernels respectively corresponding to different quantization parameter values.

3. The method of claim 2, wherein the quantization parameter value of the block is within a range to a specific quantization parameter value associated with the modified inverse transform kernel.

4. The method of claim 1, wherein the modified inverse transform kernel comprises a quantization compensation matrix, a dot product of the quantization compensation matrix with an inverse of the transform kernel corresponds to the modified inverse transform kernel.

5. The method of claim 1, further comprising:
determining a compensation strength according to the quantization parameter value of the block and a specific quantization parameter value associated with a pre-learned inverse transform kernel; and
calculating the modified inverse transform kernel according to the compensation strength and the pre-learned inverse transform kernel associated with the specific quantization parameter value.

6. The method of claim 1, wherein the determining comprises:
determining that the modified inverse transform kernel is used for the block when at least one of a block shape of the block and a block size of the block satisfies a requirement.

7. The method of claim 1, wherein the block is in a second portion of a video that is coded in the coded video bitstream after a first portion of the video, the modified inverse transform kernel is learned based on the first portion of the video, the method comprises:
decoding at least a syntax element from the coded video bitstream, the syntax element indicating a switch from the inverse of the transform kernel to the modified inverse transform kernel.

8. The method of claim 1, further comprising:
decoding values in the modified inverse transform kernel from the coded video bitstream.

9. The method of claim 1, further comprising:
storing the modified inverse transform kernel in association with the transform kernel, the modified inverse transform kernel being pre-learned for the transform kernel, the transform kernel including at least one of a primary transform kernel and/or a secondary transform kernel.

10. The method of claim 1, further comprising:
storing a plurality of modified inverse transform kernels in association with the transform kernel, the plurality of modified inverse transform kernels being pre-learned for different quantization parameter values, the transform kernel including at least one of a primary transform kernel and/or a secondary transform kernel.

11. A method of video encoding, comprising:
transforming a residual block of a block in a spatial domain to spectrum domain coefficients in a spectrum domain according to a transform kernel;
performing a quantization on the spectrum domain coefficients according to a quantization parameter value to obtain quantized spectrum domain coefficients;
encoding the quantized spectrum domain coefficients into coded information of the block in a bitstream;
determining to use a modified inverse transform kernel for a reconstruction of the block, the modified inverse transform kernel being different from an inverse of the transform kernel to compensate an influence of the quantization on the spectrum domain coefficients; and
performing the reconstruction according to the modified inverse transform kernel.

12. The method of claim 11, further comprising:
selecting the modified inverse transform kernel from a plurality of modified inverse transform kernels according to the quantization parameter value of the block, the plurality of modified inverse transform kernels respectively corresponding to different quantization parameter values.

13. The method of claim 12, wherein the quantization parameter value of the block is within a range to a specific quantization parameter value associated with the modified inverse transform kernel.

14. The method of claim 11, wherein the modified inverse transform kernel comprises a quantization compensation matrix, a dot product of the quantization compensation matrix with an inverse of the transform kernel corresponds to the modified inverse transform kernel.

15. The method of claim 11, further comprising:
determining a compensation strength according to the quantization parameter value of the block and a specific quantization parameter value associated with a pre-learned inverse transform kernel; and
calculating the modified inverse transform kernel according to the compensation strength and the pre-learned inverse transform kernel associated with the specific quantization parameter value.

16. The method of claim 11, wherein the determining comprises:
determining to use the modified inverse transform kernel for the block when at least one of a block shape of the block and a block size of the block satisfies a requirement.

17. The method of claim 11, wherein the block is in a second portion of a video that is coded into the bitstream after a first portion of the video, the modified inverse transform kernel is learned based on the first portion of the video, the method comprises:
determining the modified inverse transform kernel by a learning according to the first portion of the video; and
including at least a syntax element into the bitstream, the syntax element indicating a switch from the inverse of the transform kernel to the modified inverse transform kernel.

18. The method of claim 11, further comprising:
encoding values in the modified inverse transform kernel into the bitstream.

19. The method of claim 11, further comprising:
storing the modified inverse transform kernel in association with the transform kernel, the modified inverse transform kernel being pre-learned for the transform kernel, the transform kernel including at least one of a primary transform kernel and/or a secondary transform kernel.

20. A method of processing visual media data, the method comprising:
processing a bitstream that includes the visual media data according to a format rule, wherein:
the bitstream carries coded information of a block in a picture, the coded information including quantized spectrum domain coefficients corresponding to a residual block of the block, the residual block being transformed from a spatial domain to spectrum domain coefficients in a spectrum domain according to a transform kernel, the spectrum domain coefficients being quantized into the quantized spectrum domain coefficients according to a quantization parameter value; and
the format rule specifies that:
based on the coded information, to use a modified inverse transform kernel for the block in the picture is determined, the modified inverse transform kernel being different from an inverse of the transform kernel to compensate an influence of quantization on the spectrum domain coefficients;
a dequantization is performed on the quantized spectrum domain coefficients to obtain dequantized spectrum domain coefficients;
an inverse transform is performed on the dequantized spectrum domain coefficients according to the modified inverse transform kernel to obtain a reconstructed residual block; and
the block is reconstructed based on the reconstructed residual block.
